(19) United States
(12) Patent Application Publication
(10) Pub. No.: US 2025/0389642 A1
(43) Pub. Date: Dec. 25, 2025

(54) COLLINEAR POLARIZATION INTERFEROMETER

(71) Applicant: Wisconsin Alumni Research Foundation, Madison, WI (US)

(72) Inventors: Martin T. Zanni, Madison, WI (US); Zachary Faitz, Madison, WI (US); Dasol Im, Madison, WI (US)

(21) Appl. No.: 19/248,059

(22) Filed: Jun. 24, 2025

Related U.S. Application Data
(60) Provisional application No. 63/663,520, filed on Jun. 24, 2024.

(51) Int. Cl. G01N 21/21; G01N 21/35

(52) U.S. Cl. CPC G01N 21/21; G01N 21/35; G01N 2201/066; G01N 2201/0683

(57) ABSTRACT

Disclosed herein is a pulse splitter, spectrometers comprising the pulse splitter, and methods of using the same. Suitably, the pulse splitter may be used to prepare an interferometer. The pulse splitter utilizes an adjustable wedge module that includes a receiving wedge element, central wedge element, and collineating wedge element. Each of these elements are made of the same birefringement material and at least one of these elements is movable and configured to modulate the time separation between the first polarized radiation and the second polarized radiation.

### CROSS REFERENCE TO RELATED APPLICATIONS

This application claims the benefit of priority to U.S. Provisional Application No. 63/663,520, filed Jun. 24, 2024, the entire contents of which is incorporated by reference herein.

### STATEMENT REGARDING FEDERALLY SPONSORED RESEARCH

This invention was made with government support under 2314378 awarded by the National Science Foundation and under FA9550-23-1-0181awarded by the USAF/AFOSR. The government has certain rights in the invention.

### FIELD OF THE INVENTION

The disclosed technology is generally directed to optical devices. More particularly the technology is directed to collinear polarization interferometric devices.

### BACKGROUND OF THE INVENTION

Fourier transform spectroscopy and microscopy utilize interference to resolve frequencies and thereby generate spectra or hyperspectral images. The most common means of generating those interferences is using a Michelson interferometer, where light from a sample is split in half and the two replicas spatially and temporally overlapped. The interference is turned into a time-dependent interferogram by scanning the relative delay between the two replicas, which is then Fourier transformed to give the spectrum. When used in an imaging modality, hyperspectral images are created, whereby each pixel in the image contains an entire spectrum. These techniques are commonly employed in analytical and research laboratories in biological, chemical and materials science for distinguishing species by their chemical composition.

The Michelson interferometer design relies on splitting and then spatially recombing a beam of light, as do other spatial interferometer designs, like the common-path Sagnac interferometer or double-path interferometers. Polarization interferometers are built using a different approach. They utilize birefringent crystals to create two beams of light orthogonally polarized along the ordinary index (n₀) and extraordinary index (nₑ) optical axes of the crystal. The two orthogonal polarizations are then projected onto a common polarization axis to create the necessary interference. There are many different designs of polarization interferometers that differ in the geometry of the birefringent crystals and the way in which the orthogonally polarized beams form an interferogram. Many use Savart plates or Wollaston prisms to create non-collinearly propagating nₒ and nₑ polarized beams that are focused to create a spatially varying diffraction pattern that can be measured with a linear array. Achromatic versions exist that compensate for angular dispersion across the wedged surfaces to improve spectral resolution and the blurring of images. These designs are useful because they have no moving parts so that real-time spectra are obtained. Their spectral resolutions are determined by the spatial offsets of the polarized beams, which can be improved by double sets of birefringent optics.

Another type of polarization interferometer uses a Babinet-Soleil compensator to impart a delay between the nₒ and nₑ beams. The interferogram is generated by translating the wedge to vary the material thickness and thereby control the relative time-delay between the nₒ and nₑ beams. A commercial version of a near-IR polarization interferometer has been available since the late 1980s. The Babinet-Soleil design was adapted for ultrafast spectroscopy by Cerullo et al. with the addition of a second set of birefringent wedges to control for temporal dispersion that occurs when translating the wedges to vary the thickness of material along the nₒ and nₑ optical axes. While Babinet-Soleil interferometers require moving parts, their spectral resolution is straightforward to set by adjusting the maximum delay over which the interferogram is measured. Polarized light travels through two wedges of birefringent material cut with identical nₒ and nₑ axes and oriented generally 45 degrees to the polarization of the input light. A compensator plate exists, cut from the same material but oriented 90 degrees from the wedges, so that a zero-delay can be reached. A polarizer projects the nₒ and nₑ beams onto a common axis that is typically measured on a single pixel detector. It is generally assumed that the Babinet-Soleil interferometer is a common-path interferometer with collinearly propagating nₒ and nₑ beams. That would only be true if there is no spatial separation between the two wedges in the Babinet-Soleil compensator, but a gap is necessary to mechanically translate one wedge relative to the other, creating parallel but offset beams. As a result, when the nₒ and nₑ beams are focused onto the detector, there is incomplete interference and a spatially dependent phase. The effects are also wavelength dependent because the displacement of the polarized beams depends on wavelength. These effects decrease the signal and cause phase twisted data. The larger the gap, the bigger the aberrations.

Therefore, there is a need for interferometric devices, systems, and methods which correct for aberrations.

### BRIEF SUMMARY OF THE INVENTION

Disclosed herein is a pulse splitter including an ordered arrangement of a birefringent optical element, and an adjustable wedge module, and configured to produce a first radiation and a second radiation having a time separation. The birefringent optical element is configured to receive radiation from a radiation source and provide a time delay between a first polarized radiation and a second polarized radiation, the first polarized radiation and the second polarized radiation having orthogonal polarizations to each other. The adjustable wedge module includes: a receiving wedge element having a first angle, the receiving wedge element configured to receive the first polarized radiation and the second polarized radiation and spatially separate the first polarized radiation and the second polarized radiation; a central wedge element having a second angle through which the spatially separated first polarized radiation and the second polarized radiation traverse between the receiving wedge element and a collineating wedge element; a collineating wedge element having a third angle and configured to collineate the spatially separated first polarized radiation and the second polarized radiation. The sum of the first angle and the third angle is substantially equal to the second angle, wherein the receiving wedge element, the central wedge element, and the collineating wedge element are each composed of the same birefringent material, and at least one of the receiving wedge element, the central wedge element, or the collineating wedge element is movable and configured to modulate the time separation between the first polarized radiation and the second polarized radiation.

Further disclosed herein is a spectrometer including: a radiation source configured to generate source radiation; a first optical system including the pulse splitter described above configured to produce the first radiation and the second radiation having the time separation from the source radiation; a sample volume configured to hold a sample to be irradiated by the first radiation and the second radiation; and a detector configured to receive a signal from the sample volume.

Also disclosed herein are methods of analyzing a sample with the spectrometer described above, including the steps of: i) irradiating a sample in the sample volume with the first radiation and second radiation having the time separation; ii) detecting a signal from the sample; iii) repeating steps (i) and (ii) over a range of time separations between the first radiation and the second radiation; and iv) processing with detected signal over at least a portion of the range of time separations to produce a spectrum.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention.

FIG. 1 shows schematic setups of imaging instruments using the two different wedge configurations. Panel (a) depicts the layout of a Babinet-Soleil compensator for use in an imaging apparatus. Panel (b) depicts the layout a 3-wedge compensator device as disclosed herein for use in an imaging apparatus. Acronyms: POL=polarizer, L1=lens. Panel (c) shows an example wedge in accordance with some embodiments of the present disclosure. Dimension are given in millimeters.

FIG. 2 shows simulations which calculate the distortions in the resulting spectra for mid-infrared light when being used to image three spherical beads on a surface. Two of the beads are simulated to contain a molecule that absorbs at 4.8 microns and the other contains a different molecule that absorbs at 5.2 microns. Simulations of the 2-wedge design are performed with 1 and 10 mm spacings between the wedges. Panels a) through d) show simulations to illustrate the distortions caused by an interferometer built from a traditional 2-wedge Babinet-Soleil. Panels e) through f) show the simulations to illustrate the lack of distortions caused by the 3-wedge compensator device disclosed herein.

FIG. 3 shows a schematic illustration of a pulse splitter in accordance with some embodiments of the present disclosure. Dotted lines indicate optional components. POL=polarizer.

FIG. 4 shows a schematic illustration of a pulse splitter in accordance with some embodiments of the present disclosure. Dotted lines indicate optional components. POL=polarizer.

FIG. 5 shows a schematic illustration of a polarization interferometer in accordance with some embodiments of the present disclosure.

FIG. 6 shows a simplified block diagram of a multi-dimensional spectrometer in accordance with some embodiments of the present disclosure, using a radiation pulse processed by a first optical system to produce a probe pulse and by a second optical system to produce pump pulses.

FIG. 7 show a detailed block diagram of a portion of the second optical system generating two pump pulses from a single radiation pulse.

FIG. 8 shows a more detailed diagram of the spectrometer of FIG. 6, using the second optical system of FIG. 7.

FIG. 9 shows a flow chart for a method of analyzing a sample with the multi-dimensional spectrometer.

FIG. 10 shows a schematic illustration of a hyperspectral imaging system in accordance with some embodiments of the present disclosure. P1 and P2 are polarizers, O indicates an object, I indicates an image. Double-ended arrow indicates direction of wedge translation to alter the time delay.

FIG. 11a shows a schematic illustration of an FTIR system in accordance with some embodiments of the present disclosure. P₄₅° indicates a polarizer at 45 degrees with respect to the horizontal direction.

FIG. 11b shows a schematic illustration of a 2-dimensional FTIR system in accordance with some embodiments of the present disclosure. P₀° and P₉₀° indicate polarizer at 0° and 90° with respect to the horizontal, respectively. WBS indicates a wedged beam splitter.

FIG. 12 shows a schematic illustration of a microscopy system in accordance with some embodiments of the present disclosure.

### DETAILED DESCRIPTION OF THE INVENTION

Disclosed herein are interferometric devices, systems, and methods which correct for achromatic aberration, including a pulse splitter, a multi-dimensional spectrometer, and a method of hyperspectral imaging.

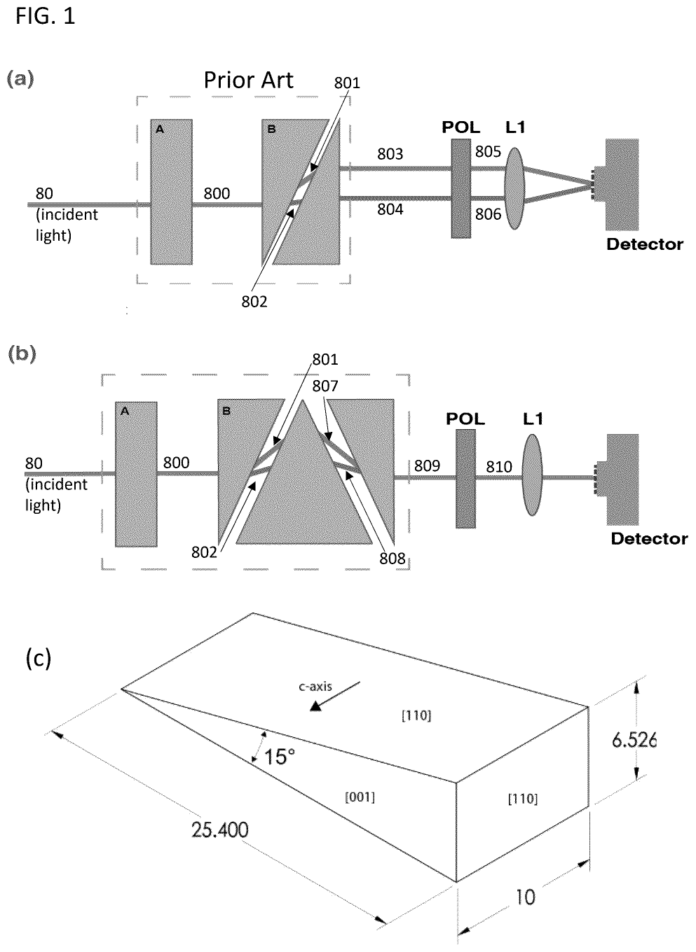

Inventors report the performance of a three-wedge design for pulse splitter that produces collinear nₒ and nₑ beam and corrects for achromatic aberrations. The three wedges are all made of the same material and cut with the same orientation of the nₒ and nₑ axes. Under these conditions, the nₒ and nₑ beam diverge in the gap between the first two wedges and then reconverge in the second gap, as drawn in FIG. 1b. As shown herein, the beam divergence is compensated even for very large optical gaps. As a result, the 3-wedge compensator device disclosed herein produces collinear nₒ and nₑ beams, resulting in larger interferograms, no phase twist, and no achromatic aberrations, as compared to a traditional Babinet-Soleil compensator shown in FIG. 1a.

Referring to the traditional Babinet-Soleil compensator in FIG. 1a, it contains three birefringent plates, generally made from the same material (e.g. crystalline quartz): one plane-parallel plate (A) and two wedges (B), where the latter have an orientation of the optical axis perpendicular to that of the plane-parallel plate. One or more of the wedges can be moved so that the effective thickness of the summed beam path through the two wedges is adjustable. Common to both a Babinet-Soleil compensator shown in FIG. 1a and an embodiment of the disclosed technology shown in FIG. 1b, radiation (80) from a radiation source incident upon the compensator plate (A) produces transmitted radiation (800) having a time delay between a first polarized radiation and a second polarized radiation, the first polarized radiation and the second polarized radiation having orthogonal polarizations to each other. In some cases, the transmitted radiation (800) is a single incident beam with a polarization angle (e.g., 45 degrees) oriented between the optical axes (nₒ and nₑ) of the first wedge (e.g., the receiving wedge element). The transmitted radiation (800) is split between projections of the nₒ and nₑ optical axes to form spatially separated first polarized radiation (801) and the second polarized radiation (802). The first wedge (e.g., a receiving wedge element) delays one of the polarized radiations more than the other polarized radiation in the opposite direction relative to the compensator plate (A).

Referring to FIG. 1a, the traditional Babinet-Soleil compensator's second wedge may be used to adjust the delay by translating the wedge into or out of the incident radiation so to alter the thickness of the wedge intersecting the path of the first and second polarized radiations to produce delayed polarized radiation (803) and the timely polarized radiation (804). A polarizer (POL) realigns the polarization of the delayed polarized radiation and the timely polarized radiation to a common polarization (805 and 806). A lens (L1) may focus the spatially separated, commonly polarized and delayed beams (805 and 806) onto a detector.

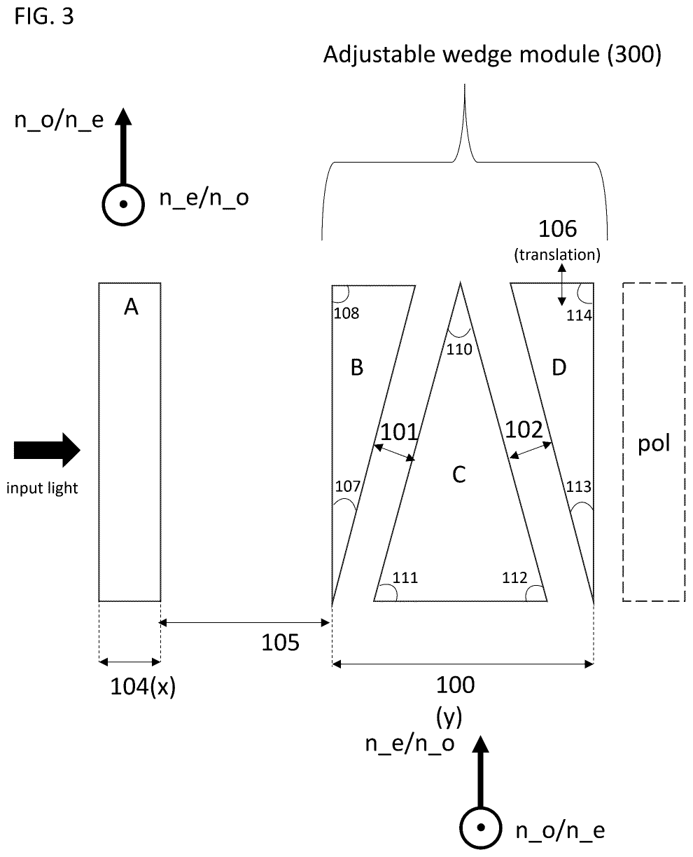

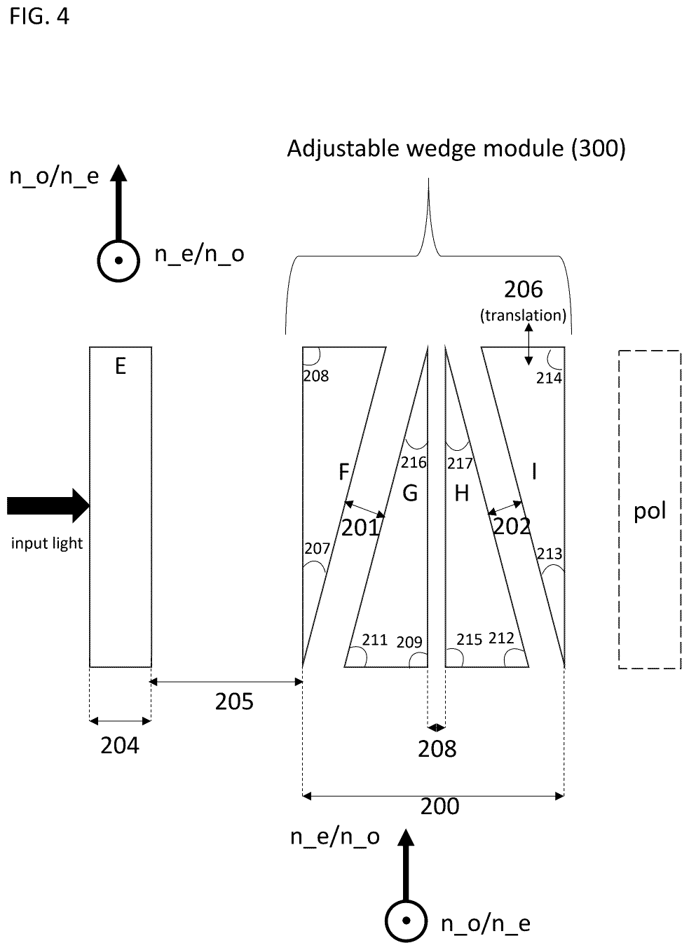

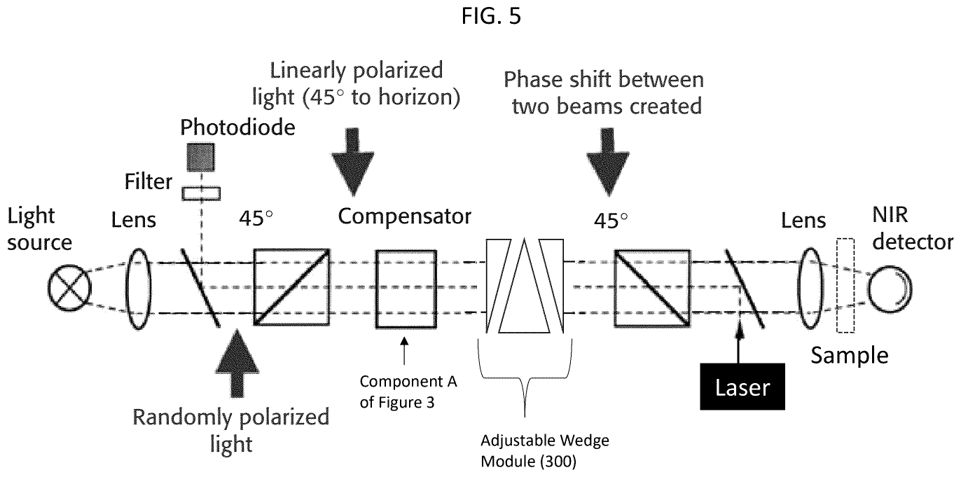

In contrast, referring to FIG. 1b, an inventive embodiment includes a central wedge element having a second angle through which the spatially separated first polarized radiation (801) and the second polarized radiation (802) traverse before reaching a collineating wedge element which collineates the spatially separated first polarized radiation (807) and the second polarized radiation (808) to produce a collineate beam of polarized radiations having orthogonal polarizations (809). Any wedges (see wedges B, C, D, F, G, H, or I of FIG. 3-4) can be used to adjust the delay by translating one or more of these aforementioned wedges so to alter the thickness of the wedge intersecting the path of the first and second polarized radiations to produce delayed polarized radiation (807) and the timely polarized radiation (808). Depending on the wedge one chooses to translate, the angle of translation changes. When translated on their own, wedges B, D, F, and I need to be translated at an angle equal to angle of wedge itself. In contrast, wedges C and G and H together need to be translated perpendicular to the incident radiation. Additionally, translating groups of wedges that would form a single rectangle when placed together do not adjust the time delay (e.g. F and G). A polarizer (POL) realigns the polarization of the delayed polarized radiation and the timely polarized radiation to a common polarization (810). A lens (L1) may focus the collinear, commonly polarized and delayed beams (810) onto a detector.

The three-wedge compensator device disclosed herein is not to be confused with “three-wedge Babinet-Soleil compensators” nor previously published 4-wedge designs that utilize different geometries and/or mixed birefringent materials whose purpose is to expand the displacement of the nₒ and nₑ beams. The three-wedge compensator device disclosed herein, on the other hand, is useful for single pixel detectors for spectroscopy as well as cameras for imaging because it produces that produces collinear nₒ and nₑ beam and corrects for achromatic aberrations. Inventors measured and simulated aberrations created by non-parallel nₒ and nₑ beams, and demonstrate improved chemical identification via hyperspectral imaging using the 3-wedge compensator device disclosed herein.

### Imaging

Babinet-Soleil interferometers have several advantages over mirror-based interferometers. For instance, they have higher stability since the two beams travel through the same optics. In fact, the fluctuations that rise from vibrations are as small as 1/360 of the optical cycle without any active stabilization. On top of these advantages, the Babinent-Soleil compensator has a 50% throughput efficiency with an ability to perform balance heterodyne detection. Despite its early introduction, the Babinet-Soleil interferometer is still not used in imaging applications because it outputs two noncollinear beams, which results in degraded image quality.

Here, Inventors introduce a novel wedge-based interferometer that utilizes three wedges shown in FIG. 1b. Inventors successfully combined the imaging capabilities of mirror-based interferometers with the stability and compactness of wedge-based interferometers. First, Inventors characterized the problems associated with noncollinear beams using Babinet-Soleil then showed how the three-wedge compensator device disclosed herein resolves the issues. Next, Inventors demonstrated the improvement in the quality of hyperspectral imaging (HSI) by comparing the quality of the images acquired using the three-wedge compensator device disclosed herein to the images formed by traditional Babinet-Soleil interferometers. While the 3-wedge compensator device disclosed herein can improve the imaging quality across all wavelengths, one embodiment specifically demonstrates the advantages of using the 3-wedge compensator device disclosed herein in the mid-IR region (e.g., 5-6 μm).

### Design

The disclosed technology achieves collinear output beams while preserving the stability of wedge-based interferometers. The 3-wedge compensator device disclosed herein includes at least 3 crystals having the same refractive indices. Referring to FIG. 3, the interfaces of wedges B and D are kept parallel to each other while keeping the gaps between wedges B to C, and C to D equal. Moreover, the wedge C has an apex angle (110) that is twice as large as the apex angle of wedges B and/or D, (107) and (113) respectively. In other words, the sum of (107) and (113) is equal to the angle of (110). Similarly, referring to FIG. 4, in a 4-wedge design, the sum of angle (216) of wedge G and angle (217) of wedge H is twice the angle (207) of wedge F and/or angle (213) of wedge I. In other words, the sum of (207) and (213) is equal to the sum of angles (216) and (217).

In some cases, angle (208, 214) may be right angles. In some cases, wedges G and H may each contain angles (209, 215) which are right angles. A first central wedge element (G) and a second central wedge element (H) may be positioned relative to one another where there is a distance (208) separating their opposite sides. In some cases, distance (208) is minimized so that the sum of wedges G and H are effectively an isosceles triangular prism. The distance (201) between the receiving wedge element (F) and the first central wedge element (G) and the distance (202) between the second central wedge element (H) and the collineating wedge element (I) may substantially equal.

Under these conditions, the two output beams of 3-wedge compensator device disclosed herein are collinear, as shown in FIG. 1b. To control the relative time delay of the two collinear beams, any of the wedges (wedges B, C, D, F, G, H, or I of FIGS. 3 and 4) may be placed on a translation stage given the restrictions described above. In some cases, the last wedge (wedges D and I of FIGS. 3 and 4, respectively) may be translated. The delay between the two replicas then can be calculated using the equation below:

$$Δ T = \frac{( {n}_{ge} - {n}_{go} ) Δ L tan ( α )}{c} \qquad 1$$

In some cases, it is desirable to translate the central wedge element (wedge C of FIG. 3). Unlike the receiving wedge element and collineating wedge element, the central wedge element should be translated in a direction perpendicular to the light entering the apparatus. In order to maintain a constant inter-wedge spacing, the receiving wedge element and collineating wedge element should be translated at angle relative to the light entering the apparatus equal to the translating wedge's angle. Translating the central wedge element changes the inter-wedge spacing but translating it perpendicularly to the direction of the light entering the apparatus will change both inter-wedge spacings equally, preserving the benefits of the optical apparatus. Even though the central wedge element is twice as thick as the receiving wedge element and collineating wedge element, the maximum resolution of the apparatus is not necessarily two times better. This effect is caused by a spatial offset between the nₒ and nₑ beams entering the central wedge element, resulting in a reduction of the usable length of the central wedge element. Put another way, one beam will start missing the central wedge element before the central wedge element has been translated its full length. The new, effective length of the central wedge element, L′, can be approximated using the following formula:

$${L}^{′} = L - ( sin ( {θ}_{e} - α ) {P}_{e} - sin ( {θ}_{o} - α ) {P}_{o} ) \qquad 2$$

where θ is the angle a given ray exits the receiving wedge element, a is the angle the receiving wedge is cut at, and P is the path length of a given ray travels between the first and second wedges. Pₑ and Pₒ can be calculated using the formulas below:

$${P}_{e} = ( A - {L}^{′} tan ( α ) ) \frac{cos ( a )}{cos ( {θ}_{e} )} \qquad 3$$

$${P}_{o} = ( A - {L}^{′} tan ( α ) ) \frac{cos ( a )}{cos ( {θ}_{o} )} \qquad 4$$

where A is defined below:

$$A = \frac{2 ( S - Dtan ( α ) )}{1 + \frac{cos ( {θ}_{e} - 2 α )}{cos ( {θ}_{e} )}} \qquad 5$$

where D is the position of the beam entering the receiving wedge element relative to the tip of receiving wedge element and S is the inter-wedge separation. For a set of wedges with length L, the minimum inter-wedge separation is 2L tan (α).

The below equation can be used to calculate the new maximum time delay (resolution):

$${τ}_{max} = \frac{2 ( {n}_{ge} - {n}_{go} ) {L}^{′} tan ( α )}{c} \qquad 6$$

where L has been replaced by L′, the effective length of the crystal. The 2 in the front of the equation accounts for the central wedge element being twice as thick as the receiving wedge element and collineating wedge element.

In one case, Inventors chose to manufacture each wedge (B, C, D of FIG. 3 and wedges F, G, H, and I of FIG. 4) out of mercurous chloride (Hg₂Cl₂), also known as calomel. Calomel is a highly birefringent crystal (Δn≈0.55) with a broad transparency range (from 400 nm to 20 μm). With exemplified wedge dimensions, the relative time separation t achievable in the mid IR (5 μm−6 μm) is τ≈13 ps, which corresponds to 1 cm⁻¹ resolution. Moreover, a higher resolution is achievable by altering the dimensions of the wedges or by translating two wedges (C and D or G, H and I). The resolution of the 3-wedge compensator device disclosed herein is dependent on the length of the longest relative time delay achievable. The time delay is dependent on the index of refraction of the birefringent material the 3-wedge compensator device is constructed with and the thickness of the adjustable wedge module (300). In general, larger wedges, including larger angles (e.g., larger angles (107), (110), (113), (207), (216), (217), (213)) will produce a larger change in thickness of the adjustable wedge module to achieve a higher resolution.

### Imaging Distortion Simulations

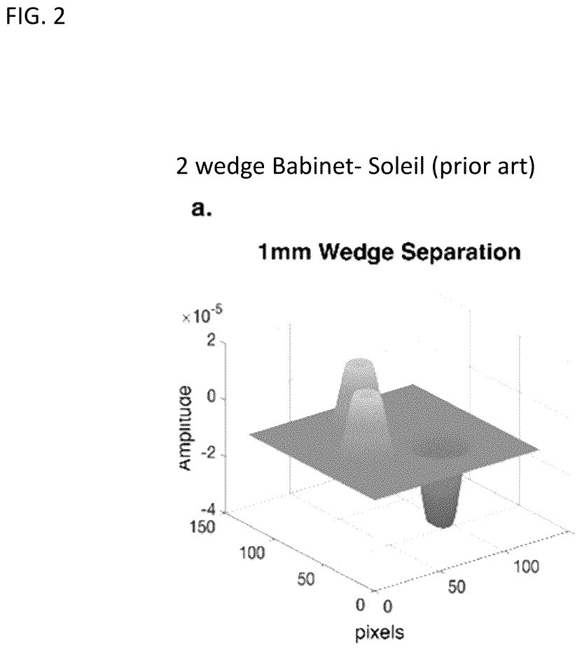

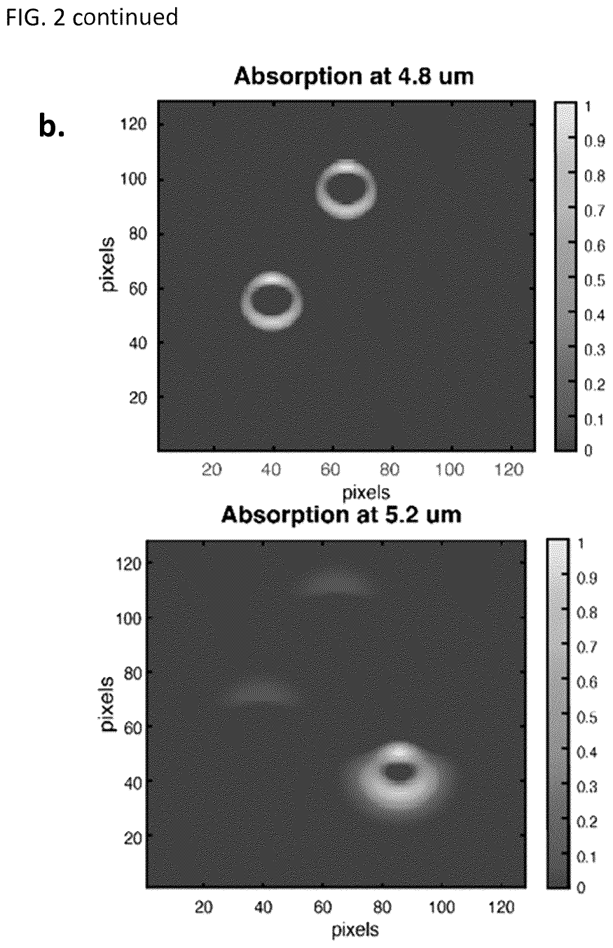

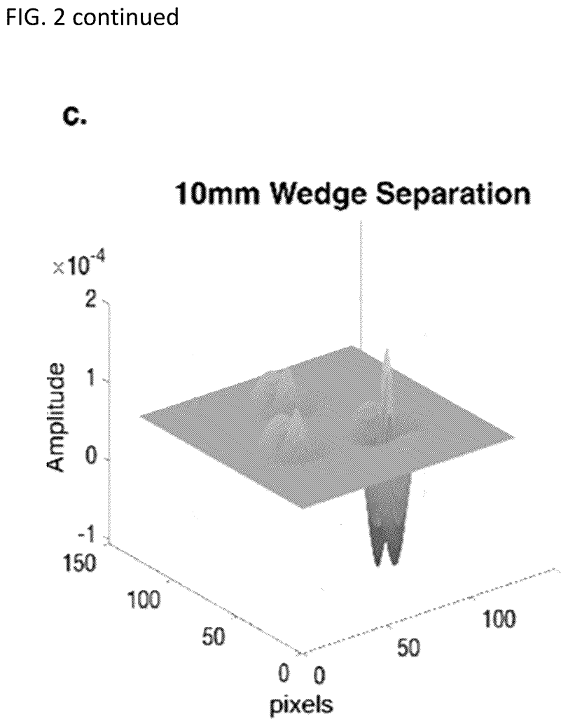

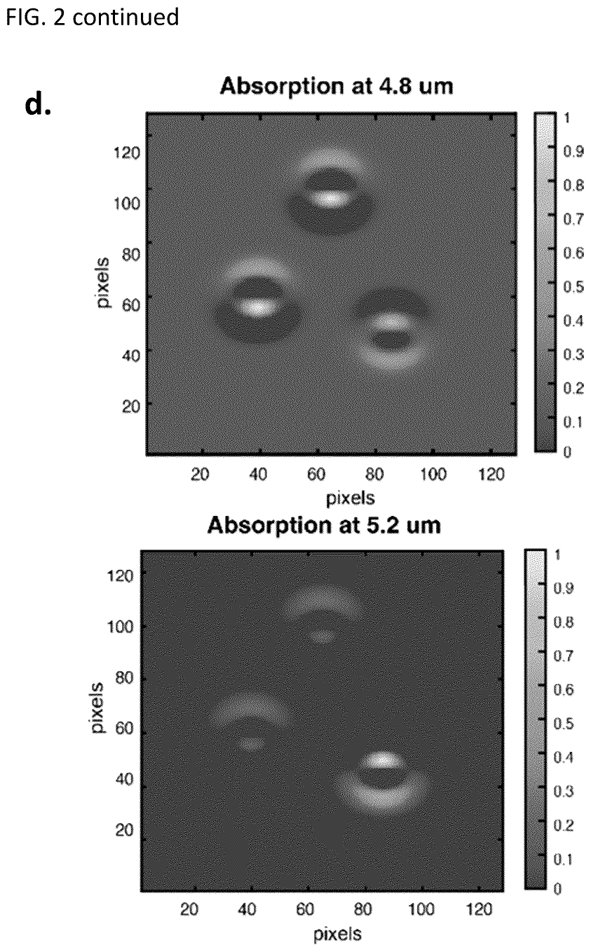

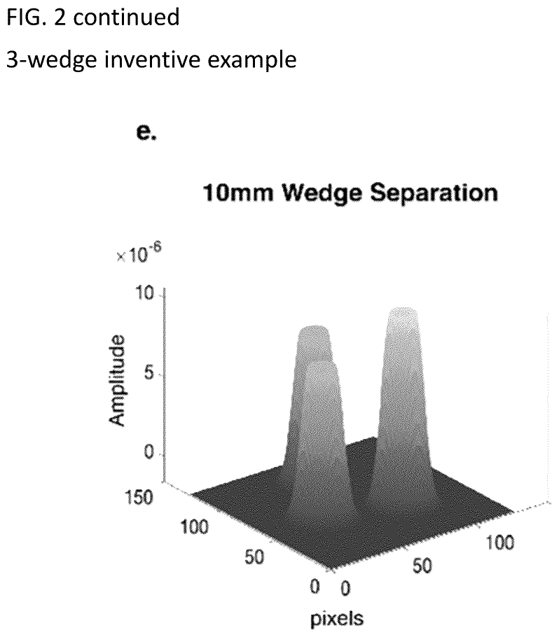

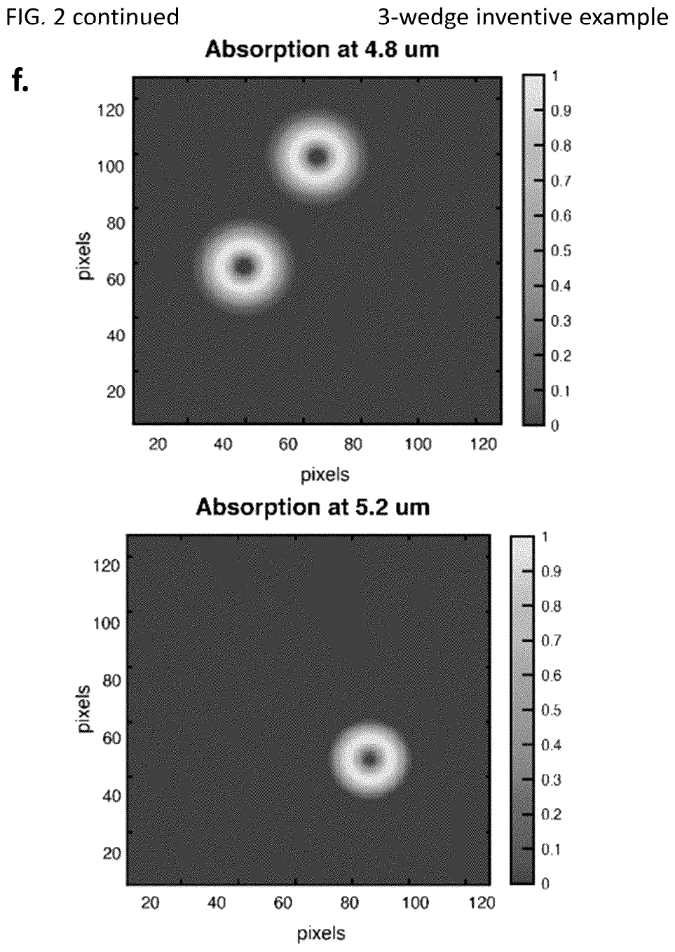

FIG. 2 displays simulations that calculate the distortions in the resulting spectra for mid-infrared light when being used to image three spherical beads on a surface. Two of the beads are simulated to contain a molecule that absorbs at 4.8 microns and the other contains a different molecule that absorbs at 5.2 microns. Simulations of the 2-wedge design are performed with 1 and 10 mm spacings between the wedges. At 1 mm separation, FIG. 2a plots the intensity at 5.0 microns. The phase of the light at the positions of two of the beads is positive while it is negative at the position of the other. FIG. 2b plots images of the intensity in resonance with each type of bead, at 4.8 and 5.2 microns; the image on the left should only contain two beads while the image on the right should only contain 1. But all 3 images contain all 3 beads. Thus, the contrast afforded by hyperspectral imaging is degraded. The distortions worsen with separation, as illustrated with the 10 mm simulations. In comparison are simulations for the 3-wedge configuration in FIGS. 2e and 2f, which are not distorted, perfectly distinguish between the two types of beads, and exhibit larger signal strengths. There are no distortions, and those characteristics hold true regardless of separation. To simulate the optical system used for hyperspectral image, Inventors used scalar-wave Fourier optics under Fresnel approximation. Using the Fresnel operators, Inventors were able to calculate the electric field at the detector often called the coherent point spread function.

### Pulse Splitter

Referring to FIGS. 3-4, disclosed herein is a pulse splitter including an ordered arrangement of a birefringent optical element (A, E), an adjustable wedge module (300), and a polarizer (pol) and configured to produce a first radiation and a second radiation having a time separation. The pulse splitter is configured to prevent chromatic aberration.

The birefringent optical element (A, E) is configured to receive radiation from a radiation source and provide a time delay between a first polarized radiation and a second polarized radiation, the first polarized radiation and the second polarized radiation having orthogonal polarizations to each other. The birefringent optical element (A, E) may have a thickness (104, 204). The birefringent optical element (A, E) may be spatially separated from the adjustable wedge module (300) by a distance (105, 205).

Referring to FIG. 3, the adjustable wedge module (300) includes a receiving wedge element (B), a central wedge element (C), and a collineating wedge element (D). The receiving wedge element has a first angle (107). The receiving wedge may receive a single incident beam with a polarization angle (e.g., 45 degrees) oriented between the optical axes (nₒ and nₑ) of the first wedge (e.g., the receiving wedge element). The radiation is split between projections of the nₒ and nₑ optical axes to form spatially separated first polarized radiation and the second polarized radiation. The receiving wedge element delays one of the polarized radiations more than the other polarized radiation. The central wedge element (C) has a second angle (110) through which the spatially separated first polarized radiation and the second polarized radiation traverse between the receiving wedge element and a collineating wedge element. In some cases, the central wedge element may be an isosceles triangular prism. In some cases, angles (111) and (112) are substantially equal. The collineating wedge element having a third angle (113) and configured to collineate the spatially separated first polarized radiation and the second polarized radiation. In some cases, the first angle (107) and/or the third angle (113) is twice the second angle (110). In some cases, the second angle (110) is twice the first angle (107). In some cases, the second angle (110) is twice the third angle (113). In some cases, the second angle (110) is equal to the sum of the third angle (113) and the first angle (107). Referring to FIG. 3, the central wedge element may include one wedge having the second angle (110). In some cases, now referring to FIG. 4, the central wedge element comprises two wedges (G and H) having equal angles (216, 217) that together form the second angle. The two wedges (G and H) that together comprise the central wedge element may be move concertedly or independently. Concerted movement may be accomplished with the use of a common actuator, such as a common micrometer or common movable stage, coupled to each of the two wedges (G and H). Independent movement may be accomplished with the use of independent actuators coupled to the two wedges (G and H). Referring to both FIGS. 3 and 4, in some cases, the receiving wedge element may include a right angle. For example, angle (108, 208) may be 90 degrees. In some cases, the collineating wedge element may include a right angle. For example, angle (114, 214) may be 90 degrees. In some cases, the receiving wedge element and the collineating wedge element may each be a right-angle triangular prism.

The distance (100, 200) is the total thickness of the adjustable wedge module (300). The distance (100, 200) may be adjusted by translation of one or more of wedges B, C, D, E, F, G, H, or I to alter the time delay of the two collinear beams exiting the adjustable wedge module (300) given the restrictions described above. The distance (101) between the receiving wedge element (B) and the central wedge element (C) and the distance (102) between the central wedge element (C) and the collineating wedge element (D) may substantially equal.

In another aspect, the receiving wedge element, the central wedge element, and the collineating wedge element are each composed of the same birefringent material. The birefringent optical element may also be composed of the same birefringent material as the receiving wedge element, the central wedge element, and the collineating wedge element. Alternatively, the birefringent optical element may also be composed of a different birefringent material than the receiving wedge element, the central wedge element, and the collineating wedge element. In some cases, the birefringent material may be calcite, a-barium borate (a-BBO), magnesium fluoride, crystal quartz, cadmium selenide, cadmium sulfide, cadmium thiogallate and cadmium germanium arsenide, silver gallium sulfide, silver gallium selenide, mercurous chloride, mercurous bromide, mercurous iodide, or any combinations thereof.

In some cases, the adjustable wedge module is configured to achieve time separation between the first polarized radiation and the second polarized radiation of more than 0.1, 0.2, 0.3, 0.4, 0.5, 0.6, 0.7, 0.8, 0.9, 1, 2, 3, 4, 5, 6, 7, 8, 9, 10, 11, 12, or 13 picoseconds. The desired time separation may depend on the application, desired resolution, wavelength of radiation, and birefringent material. In some cases, the adjustable wedge module is configured to allow for about 0.5 nm, about 1.0 nm, about 1.5 nm, or 2.0 nm resolution in the UV, visible, and/or near infrared regions. In some cases, adjustable wedge module is configured to allow for about 0.05, about 0.1, or about 0.5 wavenumber resolution in the mid-infrared to far-infrared regions.

In some cases, the birefringent material is optically transparent in the mid-IR wavelengths (about 1.5 to about 15 micrometers, about 3 to about 50 micrometers, about 3 to about 25 micrometers, or about 3 to about 5 micrometers). For example, the birefringent material may be mercurous chloride (Hg₂Cl₂, calomel). In some cases, the maximum achievable time separation between the first polarized radiation and the second polarized radiation using a receiving wedge element, a central wedge element, and a collineating wedge element each composed of a birefringent material which is optically transparent in mid-IR wavelengths, is greater than 1, 2, 3, 4, 5, 6, 7, 8, 9, 10, 11, or 12 picoseconds. In some cases, the maximum achievable time separation between the first polarized radiation and the second polarized radiation using a receiving wedge element, a central wedge element, and a collineating wedge element each composed of mercurous chloride, is greater than 1, 2, 3, 4, 5, 6, 7, 8, 9, 10, 11, or 12 picoseconds.

In another aspect, at least one of the receiving wedge element, the central wedge element, or the collineating wedge element is movable and configured to modulate the time separation between the first polarized radiation and the second polarized radiation. For example, referring to FIGS. 3-4, the collineating wedge (D and I, respectively) may be translated by a dimension (106 and 206, respectively). Any suitable means of translating at least one of the receiving wedge element, the central wedge element, or the collineating wedge element may be used. For example, with an actuator such as a micrometer or a movable stage. In some cases, two of the receiving wedge element, the central wedge element, or the collineating wedge element are movable.

As used herein, the term “wedge” refers to an optical element having at least two faces which intersect in space at an angle (e.g., a first angle, a second angle, a third angle as described above). A wedge may include an optical element which is triangular prism, a trapezoidal prism, a tetrahedron, or a parallelepiped.

The polarizer is configured to realign the polarization of the collineated first polarized radiation and the second polarized radiation to a common polarization.

### Interferometer, Spectrometer, and Microscopy Systems

The systems disclosed herein include a radiation source. The radiation source may include a radiation source configured to generate wavelengths of radiation in ultraviolet, visible, infrared, or any combinations thereof. The radiation source may include, for example, lasers, light emitting diodes, discharge lamps, broadband light sources, narrowband light sources, plasmas, globars, or tunable radiation sources (e.g., tunable mid-IR pulses from an optical parametric amplifier (OPA) pumped by an amplified Ti: sapphire laser).

The systems disclosed herein include a detector. Suitable detectors include detectors which are capable of converting photons incident on the detector to an electrical signal. There are many suitable detectors known in the art, including thermal detectors, pyroelectric detectors, photodetectors (e.g., photodiodes, photoconducting detectors), array detectors (e.g., focal plane array detector, CCD array, etc), Mercury Cadmium Telluride (MCT) detector, photon counting detectors, and active pixel sensors (e.g., CMOS detectors).

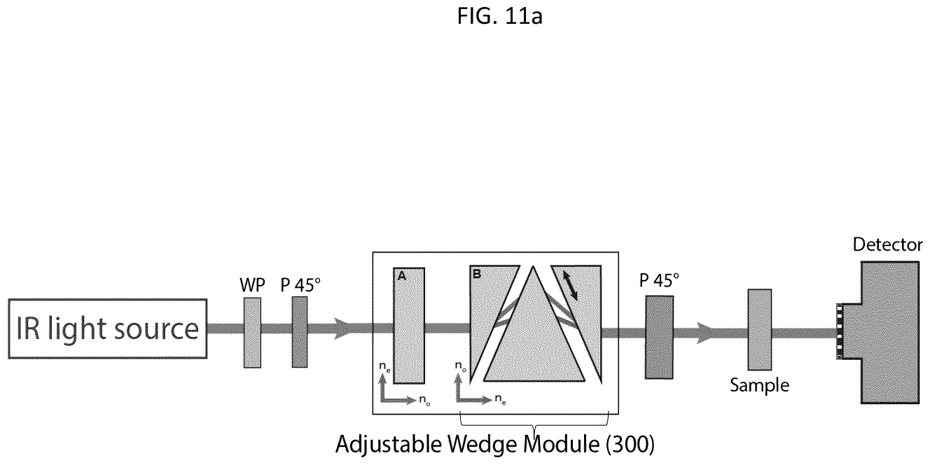

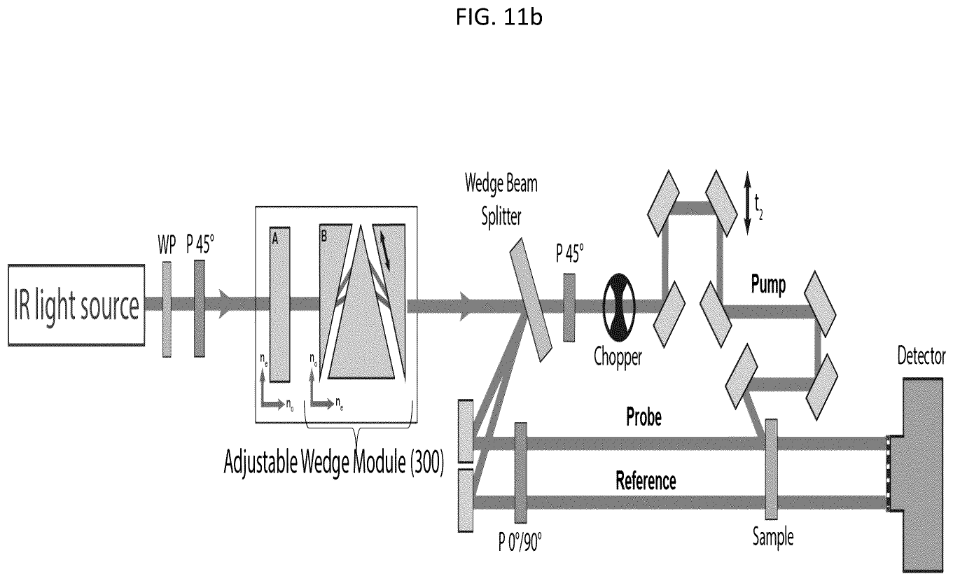

Disclosed herein are interferometers including the above-described pulse splitter. For example, FIG. 5 shows an interferometer using a 3-wedge pulse splitter as described above, a radiation source and a detector. One or more polarizers may also be position in the beam path. A sample may be placed anywhere in the beam path. In some cases, a sample may be placed after the last lens and before the detector. In some cases, an additional lens (not shown) is needed to compensate for signal divergence through the sample. Further embodiments of FTIR and 2D FTIR interferometric systems are shown in FIGS. 11a and 11b, respectively. As shown in FIG. 11b), the systems may further include dispersing the pulses by a monochromator before being detected by a detector. Suitable interferometers for use with devices, systems, and methods disclosed herein are further described in J. Rehault, R. Borrego-Varillas, A. Oriana, C. Manzoni, C. P. Hauri, J. Helbing, and G. Cerullo, “Fourier transform spectroscopy in the vibrational fingerprint region with a birefringent interferometer,” Opt. Express 25, 4403-4413 (2017), which is incorporated by reference in its entirety herein.

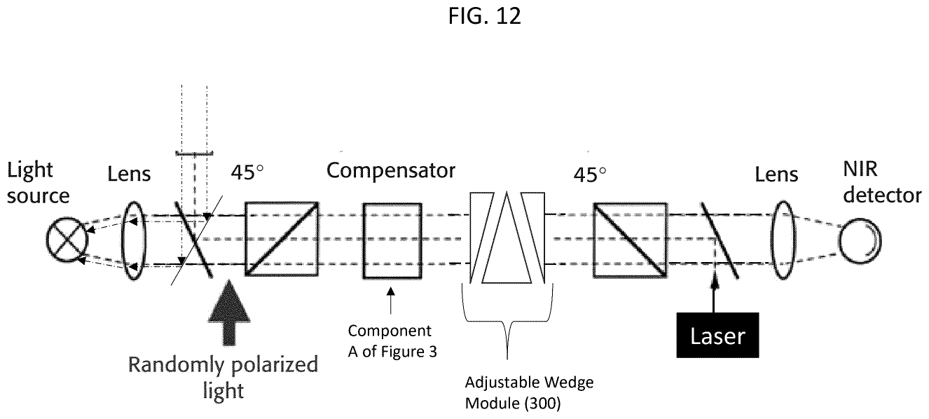

Also described herein are microscopy system including the above-described pulse splitter. For example, FIG. 12 shows a microscopy system including the using a 3-wedge pulse splitter as described above, a radiation source and a detector. The microscopy systems disclosed herein may be outfitted with one or more focusing and collection optics (e.g., objective lenses) for illuminating and collecting transmitted, reflected, or emitted photons from a sample. The microscopy system may further include other optical components, including one or more dichroic mirrors. Wide field and narrow field (e.g, confocal) microscopy systems may be used.

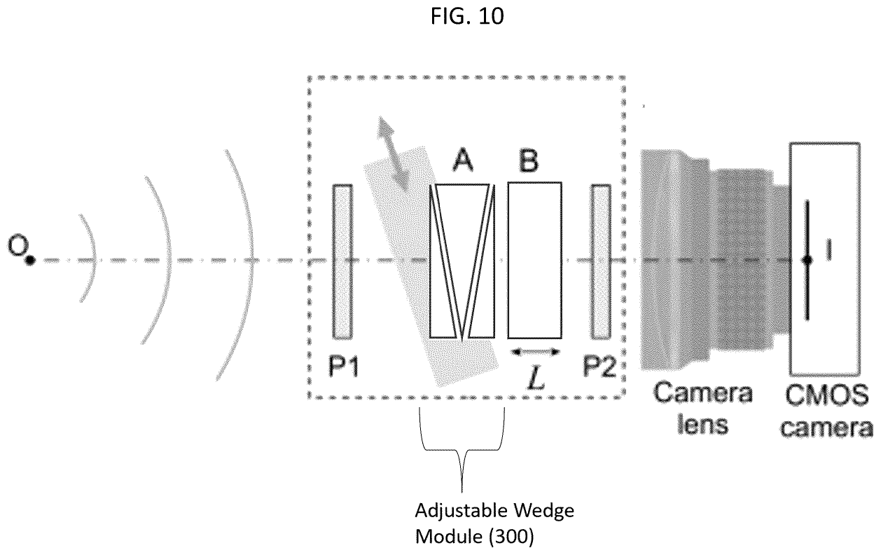

Also described herein are hyperspectral imaging systems including the above-described pulse splitter. Hyperspectral imaging systems generate images where each pixel in the image contains an entire spectrum. For example, FIG. 10 shows a hyperspectral imaging system using the above-described pulse splitter, collecting a hyperspectral image (I) of an object (O) on an array detector, such as a CMOS camera. Adjustable wedge element (300), which is also indicated as element A, and B are birefringent elements and P1 and P2 are polarizers, such as a wire-grid polarizer. P1 may polarize the input by 45° with respect to the optical axes of A and B. L defines the thickness of birefringent element B. One or more elements of adjustable wedge module (300) may be actuated, e.g., one or more elements may be placed on a movable stage and allowed to travel as indicated by the double-sided arrow. Suitable hyperspectral imaging systems for use with devices, systems, and methods disclosed herein are further described in A. Perri, B. E. Nogueira de Faria, D. C. Teles Ferreira, D. Comelli, G. Valentini, F. Preda, D. Polli, A. M. de Paula, G. Cerullo, and C. Manzoni, “Hyperspectral imaging with a TWINS birefringent interferometer,” Opt. Express 27, 15956-15967 (2019), which is incorporated by reference in its entirety herein.

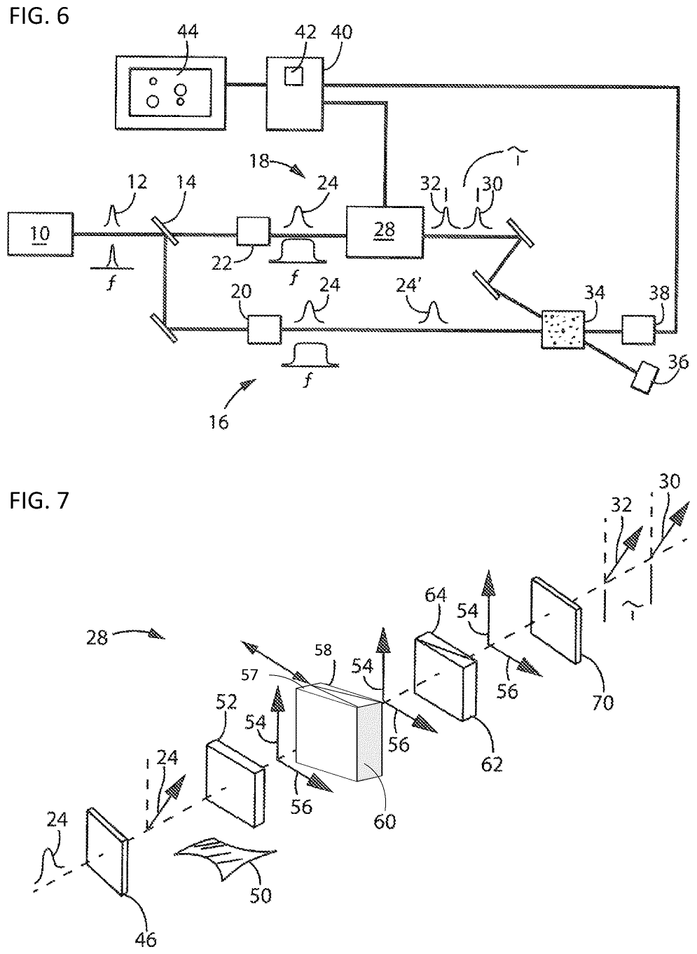

Also disclosed herein are spectrometer systems making use of the above-described pulse splitter. In some embodiments, suitable multi-dimensional spectrometers are described in U.S. Pat. No. 9,638,634, which is incorporated in its entirety by reference herein. Referring now to FIG. 6, a radiation source 10 may provide a stream of pulses 12 directed to a beam splitter 14 directing part of the energy of each of the pulses 12 both to a first optical system 16 and second optical system 18 to develop probe and pump pulses respectively. In some cases, the radiation source may provide radiation in ultraviolet wavelengths, visible wavelengths, infrared wavelengths, near-infrared wavelengths, mid-infrared wavelengths, far-infrared wavelengths, or any combinations thereof. Radiation sources may include broadband radiation sources, narrow band radiation sources, or any combination thereof.

Pulses 12 output from the beam splitter 14 are received by a first and second spectrum-broadening crystal 20 and 22 each producing a supercontinuum radiation pulse 24. A wavelength bandwidth of the radiation pulses 24, for example, may range from wavelength between 400-1400 nanometers (and hence having a bandwidth of no less than 1000 nanometers). The invention contemplates a bandwidth of no less than 900 nanometers or no less than 700 nanometers. Generally, the bandwidth will exceed 1½ octaves and will include the wavelength of 1000 nanometers.

In the first optical system 18, the radiation pulse 24 may be received by a pulse splitter 28 which controllably splits the radiation pulse 24 into first and second pump pulses 30 and 32 of substantially equal energy and frequency profile but separated in time by a time value t. The pump pulses 30 and 32 are directed through a sample volume 34 holding a sample to be analyzed (either by absorption or reflection). Pump pulses 30 and 32 leaving the sample volume 34 may be absorbed by an absorber 36.

In the second optical system 16, the radiation pulse 24 is used as a probe pulse 24′ and may pass through the sample volume 34 to be received by a detector 38, for example, a spectroscope, after stimulation of the material in the sample volume 34 by the pump pulses 30 and 32. A signal from the detector 38 after receipt of the probe pulse 24′ is received by an electronic computer 40 which may also control the pulse splitter 28 to change the value of τ. Generally electronic computer 40 will execute a stored, program 42 held in solid state memory or other non-transient memory structure to perform repeated “experiments” in which pump pulses 30 and 32 are used to excite material within the sample volume 34, which material is then analyzed by a probe pulse 24′ (substantially identical in spectrum to radiation pulse 24).

Successive experiments may provide for different values of t so as to generate information necessary to produce a two-dimensional spectrogram 44 of a type generally understood in the art. Individual experiments with the same value of τ may also be repeated and aggregated for the purpose of reducing measurement noise.

Referring now to FIG. 7, in one embodiment the pulse splitter 28 may provide a pulse encoding system similar to the translating, wedge-based, identical pulse encoding system (TWINS), for example, as described in D. Brida, C. Manzoni, G. Cerullo, “Phase-locked pulses for two-dimensional spectroscopy by a birefringent delay line”, Optics letters 37, 3027 (Aug. 1, 2012) hereby incorporated in its entirety by reference herein.

In this system, a radiation pulse 24 having a first polarization of 45 degrees with respect to a surface such as an optical table 50 (indicated in the figure by an arrow) is generated by a wave plate 46. The polarized radiation pulse 24 is then received by a birefringent optical element 52 with an optical axis cut perpendicular to the surface of the table 50. The birefringent optical element 52 splits the radiation pulse 24 into vertically and horizontally polarized pulses 54 and 56 with some fixed time delay between them.

Next a trio of wedges 57, 58, and 60 with optical axes cut parallel to the surface of the table 50 and perpendicular to the beam propagation axis are used to adjust the separation between pulses 54 and 56 by selectively delaying one pulse. This adjustment may be used to change value of τ in the pump pulses 30 and 32. Generally this adjustment is provided by physically moving one of the wedges (e.g. 58) by attachment of the wedge to the mechanical stage or actuator (not shown) controllable by the computer 40 (shown in FIG. 6) to change a thickness of the wedge intersecting the path of the pulses 54 and 56.

Optionally, a second pair of wedges 62 and 64 downstream from wedges 58 and 60, with the optical axis cut parallel to both the surface of the table 50 and to the beam propagation, is used to fix the relative timing between the second pump pulse 32 and the probe pulse 24′, as will be discussed below, as well as partially correcting the frequency dispersion of the two pump pulses 30 and 32 that would otherwise be generated by changing of the amount of material in the beam path with the first two wedges 58 and 60. Optionally, a polarizer 70 is used after the wedges 57, 58, 60, 62 and 64 to realign the polarization of the pump pulses 30 and 32 to a common polarization and to set the final polarization of the pump pulses 30 and 32, for example, to be either parallel or perpendicular to the probe pulse 24′.

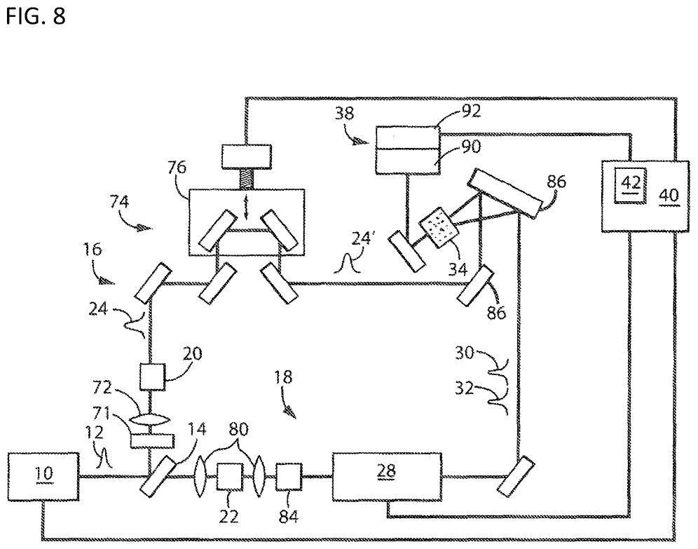

Referring now to FIG. 8, the radiation source 10, may include a radiation source configured to generate wavelengths of radiation in ultraviolet, visible, infrared (e.g, near-infrared, mid-infrared, or far-infrared), or any combination thereof. The radiation source may include, for example, lasers, light emitting diodes, discharge lamps, broadband light sources, narrowband light sources, plasmas, or globars. In one example produce narrow spectrum pulses 12 having a center frequency of 800 nanometers and a duration of 150 femtoseconds with a one kilohertz repetition rate and a per pulse energy of 300 μJ. A laser suitable for this purpose is commercially available from Spectra Physics of California, United States under the trade name Spitfire.

After passing through the beam splitter 14, narrow spectrum pulses 12 may be received along the first optical path through a polarizing wave plate 71, collimating lens assembly 72 and spectrum-broadening crystal 20.

The radiation pulse 24 is then received by a mirror array 74 providing an adjustable path length by means of a mechanically movable stage 76 controllable by the computer 40 as may be used to arbitrarily delay the radiation pulse 24 with respect to the pump pulses 30 and 32 to produce the probe pulse 24′. The delay may be adjusted as necessary to capture the desired chemical phenomenon by the spectroscope.

After the beam splitter 14, narrow spectrum pulse 12 may also be received by a collimating optical assembly 80 on the second optical system 18 and by the second spectrum-broadening crystal 20 to produce radiation pulse 24. Both spectral broadening crystals 20 and 22 may, for example, be four millimeter thick yttrium aluminum garnet (YAG) crystal.

A prism compressor 84 may then precompensate the radiation pulse 24 against dispersion introduced by the pulse splitter 28. The radiation pulse 24 is then is split into two pump pulses 30 and 32 following the pulse splitter 28.

The pump pulses 30 and 32 and probe pulse 24 are then received by a mirror array 86 to be focused through the sample volume 34 with light from the probe pulse 24′ only being directed to the detector 38. The detector, for example, may be a 150 mm focal length spectrometer 90, for example, the Acton SP-2150 spectrograph commercially available from Princeton Instruments of New Jersey, United States, coupled with a light detector using an InGaAs photodiode array 92, for example, the OMA-V:512-1.7 also commercially available from Princeton Instruments. References to “a controller” and “a processor” can be understood to include one or more controllers or processors that can communicate in a stand-alone and/or a distributed environment(s), and can thus be configured to communicate via wired or wireless communications with other processors, where such one or more processor can be configured to operate on one or more processor-controlled devices that can be similar or different devices. Furthermore, references to memory, unless otherwise specified, can include one or more processor-readable and accessible memory elements and/or components that can be internal to the processor-controlled device, external to the processor-controlled device, and can be accessed via a wired or wireless network.

### Methods

In another aspect, disclosed herein is a method of analyzing a sample with the systems described above. The methods disclosed herein may be used to generate hyperspectral data cube, wherein each data cube is associated with at least an identified location of the incident radiation source on the sample and a spectrum. In some cases, the methods disclosed herein may produce hyperspectral images wherein each pixel of the hyperspectral image includes a spectrum. In some cases, the hyperspectral image may be registered or associated with another imaging or characterization modality, such as bright field imaging, dark field imaging, a photograph, or another method of imaging or mapping a sample volume.

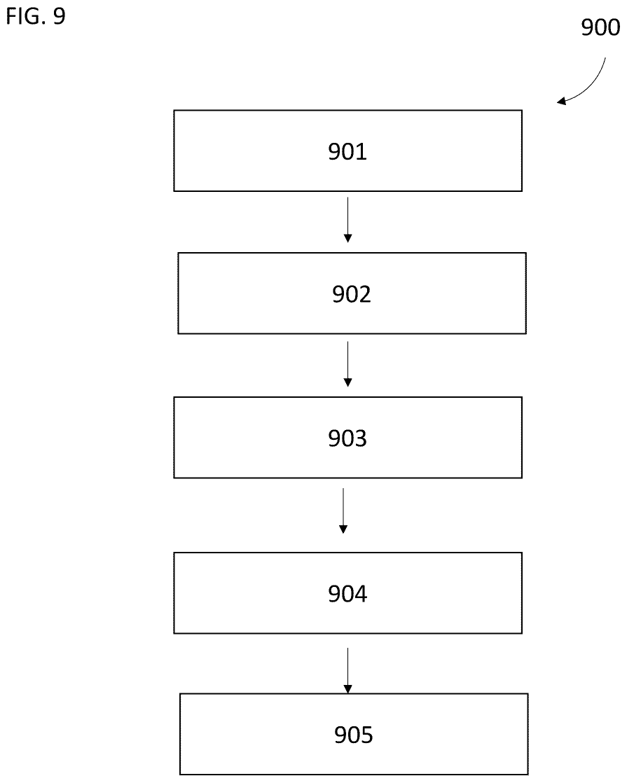

Referring to FIG. 9, the method (900) may include steps of: i) irradiating a sample in the sample volume with the first radiation and second radiation having the time separation (901); ii) detecting a signal from the sample (902); iii) repeating steps (i) and (ii) over a range of time separations between the first radiation and the second radiation (903); iv) processing with detected signal over at least a portion of the range of time separations to produce a multi-dimensional spectrum (904). The method may further include repeating steps (i)-(iii) over a plurality of sample volume locations (905). In some cases, the sample volume may move relative to the first radiation and the second radiation using a sample actuator. In some cases, the first radiation and the second radiation may move relative to the sample volume. In some cases, the first radiation and the second radiation may be scanned using further scanning optics.

In some cases, the method further includes irradiating the sample with a third radiation. The third radiation may be generated with an independent radiation source or it may be produced by splitting off an existing radiation source, such as radiation source (10) of FIGS. 6 and 8 by, for example, a second optical system. The third radiation source may be up converted or down converted relative to the radiation source, the first radiation, and/or the second radiation. In some cases, the first radiation and second radiation are in the mid-infrared wavelengths. In some cases, the sample is irradiated with the first radiation and the second radiation having a time separation greater than 1, 5, 10, 20, 30, 40, 50, 60, 70, 80, or 100 picoseconds. In some cases, the sample is irradiated with a first radiation having a mid-IR wavelength and a second radiation having a mid-IR wavelength and having a time separation greater than 1, 5, 10, 20, 30, 40, 50, 60, 70, 80, or 100 picoseconds.

In some cases, step iv), processing with detected signal over at least a portion of the range of time separations to produce a multi-dimensional spectrum (904), may be performed continuously, semi-continuously, or in a batch mode.

Unless otherwise specified or indicated by context, the terms “a”, “an”, and “the” mean “one or more.” For example, “a molecule” should be interpreted to mean “one or more molecules.”

As used herein, “about”, “approximately,” “substantially,” and “significantly” will be understood by persons of ordinary skill in the art and will vary to some extent on the context in which they are used. If there are uses of the term which are not clear to persons of ordinary skill in the art given the context in which it is used, “about” and “approximately” will mean plus or minus ≤10% of the particular term and “substantially” and “significantly” will mean plus or minus >10% of the particular term. For example, the term “substantially equal” as used herein, refers to the comparison of two or more values which are within plus or minus 0.5%, 1.0%, 1.5%, 2.0%, 2.5%, 3.0%, 3.5%, 4.0%, 4.5%, 5.0%, 5.5%, 6.0%, 6.5%, 7.0%, 7.5%, 8.0%, 8.5%, 9.0%, 9.5%, or 10.0% of one another.

As used herein, the terms “include” and “including” have the same meaning as the terms “comprise” and “comprising.” The terms “comprise” and “comprising” should be interpreted as being “open” transitional terms that permit the inclusion of additional components further to those components recited in the claims. The terms “consist” and “consisting of” should be interpreted as being “closed” transitional terms that do not permit the inclusion additional components other than the components recited in the claims. The term “consisting essentially of” should be interpreted to be partially closed and allowing the inclusion only of additional components that do not fundamentally alter the nature of the claimed subject matter.

All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

All references, including publications, patent applications, and patents, cited herein are hereby incorporated by reference to the same extent as if each reference were individually and specifically indicated to be incorporated by reference and were set forth in its entirety herein.

Preferred aspects of this invention are described herein, including the best mode known to the inventors for carrying out the invention. Variations of those preferred aspects may become apparent to those of ordinary skill in the art upon reading the foregoing description. The inventors expect a person having ordinary skill in the art to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A pulse splitter comprising an ordered arrangement of a birefringent optical element, and an adjustable wedge module, and configured to produce a first radiation and a second radiation having a time separation,
wherein the birefringent optical element is configured to receive radiation from a radiation source and provide a time delay between a first polarized radiation and a second polarized radiation, the first polarized radiation and the second polarized radiation having orthogonal polarizations to each other;
wherein the adjustable wedge module comprises:
a receiving wedge element having a first angle, the receiving wedge element configured to receive the first polarized radiation and the second polarized radiation and spatially separate the first polarized radiation and the second polarized radiation;
a central wedge element having a second angle through which the spatially separated first polarized radiation and the second polarized radiation traverse between the receiving wedge element and a collineating wedge element;
a collineating wedge element having a third angle and configured to collineate the spatially separated first polarized radiation and the second polarized radiation,
wherein the sum of the first angle and the third angle is substantially equal to the second angle,
wherein the receiving wedge element, the central wedge element, and the collineating wedge element are each composed of the same birefringent material, and
wherein at least one of the receiving wedge element, the central wedge element, or the collineating wedge element is movable and configured to modulate the time separation between the first polarized radiation and the second polarized radiation.

2. The pulse splitter of claim 1, further comprising a polarizer; and
wherein the polarizer is configured to realign the polarization of the collineated first polarized radiation and the second polarized radiation to a common polarization.

3. The pulse splitter of claim 1, wherein the pulse splitter is configured to prevent chromatic aberration.

4. The pulse splitter of claim 1, wherein the central wedge element comprises one wedge having the second angle.

5. The pulse splitter of claim 1, wherein the central wedge element comprises two wedges having equal angles that together form the second angle.

6. The pulse splitter of claim 1, wherein the birefringent optical element, the receiving wedge element, the central wedge element, and the collineating wedge element are each composed of the same birefringent material.

7. The pulse splitter of claim 1, wherein the birefringent material is optically transparent in the mid-infrared.

8. The pulse splitter of claim 7, wherein the pulse splitter is configured to achievable a time separation between the first polarized radiation and the second polarized radiation greater than 10 ps.

9. The pulse splitter of claim 1, wherein the birefringent material is Hg₂Cl₂.

10. A spectrometer comprising:
a radiation source configured to generate source radiation;
a first optical system comprising the pulse splitter of claim 1 configured to produce the first radiation and the second radiation having the time separation from the source radiation;
a sample volume configured to hold a sample to be irradiated by the first radiation and the second radiation; and
a detector configured to receive a signal from the sample volume.

11. The spectrometer of claim 10 further comprising a second optical system configured to direct a third radiation to the sample volume.

12. The spectrometer of claim 10, further comprising an electronic computer system configured to control the time separation between the first radiation and the second radiation.

13. The spectrometer of claim 10, further comprising an electronic computer system configured to control the position of the sample volume.

14. The spectrometer of claim 10, wherein the radiation source is configured to provide mid-infrared radiation, near-infrared radiation, visible radiation, ultraviolet radiation, or any combination thereof.

15. The spectrometer of claim 10, wherein the radiation source is configured to provide mid-infrared radiation.

16. The spectrometer of claim 15, wherein the multi-dimensional spectrometer is configured to achieve a time separation between the first radiation and the second radiation greater than 10 ps.

17. A method of analyzing a sample with the spectrometer of claim 10:
i) irradiating a sample in the sample volume with the first radiation and second radiation having the time separation;
ii) detecting a signal from the sample;
iii) repeating steps (i) and (ii) over a range of time separations between the first radiation and the second radiation;
iv) processing with detected signal over at least a portion of the range of time separations to produce a spectrum.

18. The method of claim 17, further comprising irradiating the sample with a third radiation.

19. The method of claim 17, further comprising repeating steps (i)-(iii) over a plurality of sample volume locations.

20. The method of claim 17, wherein the first radiation and second radiation are in the mid-infrared.
